(19) United States
(12) Patent Application Publication
(10) Pub. No.: US 2013/0054085 A1
(43) Pub. Date: Feb. 28, 2013

(54) DETECTION CIRCUIT FOR OPEN OR INTERMITTENT MOTOR VEHICLE BATTERY CONNECTION

(71) Applicant: Colin Jay Casey, Fort Wayne, IN (US)

(72) Inventor: Colin Jay Casey, Fort Wayne, IN (US)

(73) Assignee: International Truck Intellectual Property Company, LLC, Lisle, IL (US)

(21) Appl. No.: 13/643,418

(22) PCT Filed: May 18, 2010
(86) PCT No.: PCT/US10/35186

§ 371 Date: Oct. 25, 2012

(51) Int. Cl. H02J 7/14; B60L 1/00; G01M 17/00

(52) U.S. Cl. 701/34.4; 307/9.1; 307/10.1

(57) ABSTRACT

A motor vehicle electrical power system provides monitoring of the connection between a vehicle battery and a direct current power source for charging the battery. A voltage transient detector determines if voltage levels on the connection between the vehicle battery and the direct current power supply exceed a minimum threshold. Additionally, a timer or low pass filter passes only voltage transients of a minimum duration. Responsive to detection of a voltage transient exceeding the minimum threshold and duration a load dump event is signaled indicating a possible transient interruption of the connection between the vehicle battery and the direct current power source has occurred.

### BACKGROUND

1. Technical Field

The technical field relates generally to monitoring the connections between a motor vehicle electrical system and a battery.

2. Description of the Problem

Electrical systems for internal combustion engine based motor vehicles include electrical loads, generators or alternators for generating electricity, rechargeable batteries for storing electrical power potential in chemical form and distribution wiring including power buses. Cabling and clamps which connect the electrical system, particularly the generator or alternator, to the vehicle battery are subject to coming loose or otherwise failing. Loss of connection from the alternator to the battery can lead to discharge of the battery. A resulting reduced state of charge may be insufficient for later restart of the vehicle and deep discharge of the battery can result in damage to the battery.

Battery clamp monitoring and testing is known. U.S. Pat. No. 3,889,248 provided a faulty battery connection indicator that included a high resistance indicator lamp and fuse connected between cabling and a battery terminal parallel to a battery clamp. Increased resistance due to corrosion between the terminal and clamp resulted in increased current flow through the indicator lamp, resulting in light emission, and increased cumulative current through the fuse which opened the fuse indicated excess corrosion. U.S. Pat. No. 6,667,624 provides connection testing apparatus incorporated into a battery charger.

### SUMMARY

A motor vehicle electrical power system provides monitoring of the connection between a vehicle battery and a direct current power source for charging the battery. A voltage transient detector determines if voltage levels on the connection between the vehicle battery and the direct current power supply exceed a minimum threshold. Additionally, a timer or low pass filter passes only those voltage transients which exceed a minimum duration. Responsive to detection of a voltage transient exceeding the minimum threshold and minimum duration, a load dump event is signaled indicating a possible transient interruption of the connection between the vehicle battery and the direct current power source has occurred. The occurrence of such voltage transients serves as criteria indicating a loose or failing battery to direct current source connection.

### BRIEF DESCRIPTION OF THE DRAWINGS

FIG. 1 is a high level schematic of a vehicle electrical power generation, storage and distribution system.

FIG. 2 is a schematic of an equivalent circuit providing battery connection monitoring.

FIGS. 3A-C graphically illustrate generation of a logic high pulse consistent with interruption of the circuit connecting a vehicle alternator with a vehicle battery.

### DETAILED DESCRIPTION

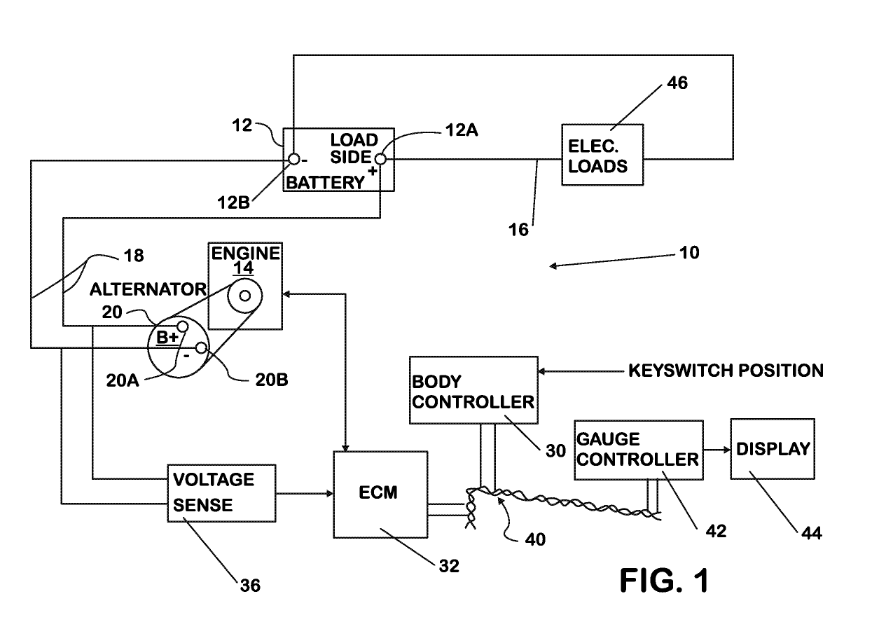

Referring to FIG. 1, a high level schematic of a vehicle electrical power system 10 is illustrated. The electrical power system 10 chosen to illustrate a possible environment of application of the management system taught in this patent document includes chassis battery 12, an alternator 20 and various electrical loads 46. Chassis battery 12 provides electrical power from its positive terminal 12A to support cranking of thermal engine 14 by a starter motor (not shown) and, when thermal engine 14 is off and power is not available from alternator 20, can be used to supply power to electrical loads 46. Alternator 20, which is driven by thermal engine 14, the vehicle's prime mover, is connected by its output terminal 20A to positive terminal 12A of chassis battery 12 to serve as an electrical power source for maintaining the state of charge of a chassis battery 12 and supplying power to electrical loads 46. When chassis battery 12 has a full state of charge and thermal engine 14 is running, alternator 20 supplies power over a power bus 16 to electrical loads 46 with chassis battery 12 providing supplementary voltage stabilization functions (holding voltage on cabling 18 to battery voltage) and supplying supply power during periods when alternator 20 output is low. Chassis battery 12 and alternator 20 are connected by their negative terminals 12B, 20B, usually through a common chassis ground. Power bus 16 is connected to positive terminal 12A and negative terminal 12B of battery 12. Cabling 18 provides a connection between the positive terminal 12A of chassis battery 12 to the positive or output terminal 20A of alternator 20 and the negative terminal 12B of chassis battery 12 to the negative terminal 20B of the alternator 20.

Incipient problems in the connection between alternator 20 and chassis battery 12 may first occur as intermittent interruptions of the connection between alternator 20 and chassis battery 12 due to vibration from operation of the vehicle or heating and cooling of cabling 18. During operation of thermal engine 14, when alternator 20 is generating power, interruptions in the connection between chassis battery 12 and alternator 20, or between either component and chassis ground, interrupts the charging circuit from alternator 20 to battery 12. Due to the inherent inductiveness of the alternator 20, these interruptions produce a “load dump” transient voltage spike on the cabling 18 connecting the alternator 20 to battery 12. This transient voltage spike rises from the normal battery voltage of about fourteen volts up to a voltage of much greater than fourteen volts. Such transient voltage spikes can be detected using a voltage sensor 36 connected to cabling 18. Voltage sensor 36 provides a voltage measurement to an engine control module (ECM) 32 or, alternatively, to a body controller 30. Appropriate analog to digital conversion of the measurements may be incorporated in the ECM 32, body controller 30, some other microcontroller, or the voltage sensor 36.

ECM 32 is illustrated as connected to a voltage sensor 36 which monitors the voltage on battery positive terminal 12A of chassis battery 12. Normally the ECM 32 would be used to provide a J1939 message that a voltage transient has occurred. Body controller 30 is an electronic control system element which can be programmed to analyze the voltage measurement signal to determine if interruptions in the connection between alternator 20 and chassis battery 12 are occurring. Although the signal to the body controller 30 over the serial datalink 40 is usually heavily filtered by the ECM 32 software, and the body controller would not be able to read specific occurrences of voltage transients from J1939 messages, the body controller is itself an electrical load power from the DC power bus 16 and can perform its own monitoring of voltage levels on the battery terminals 12A, 12B. If voltage transient spikes consistent with interruption of the alternator 20/chassis battery 12 circuit are occurring, indication of such may be passed to a gauge controller 42 for generation of a warning on a cab display 44. This can be done before the connection is lost completely or seriously compromised. In other words, such a failure is “predicted” in time for preventive maintenance, which also stems possible damage to electrical loads 46 connected to direct current power bus 16 from voltage transients.

The distribution of functions between ECM 32 and body controller 30 is given as an example only, and the functions could be differently, including on controllers not shown. One such implementation could be to provide a direct digital implementation with an analog to digital (A/D) converter built converter built into the body controller 30, possibly with addition of a voltage divider circuit ahead of the A/D converter. The timing window would then be built into the sample and compare cycle. For example, five samples exceeding the (voltage divided adjusted threshold) voltage in a 20 sample rolling window (first in, first out) with a 10 millisecond space between consecutive samples

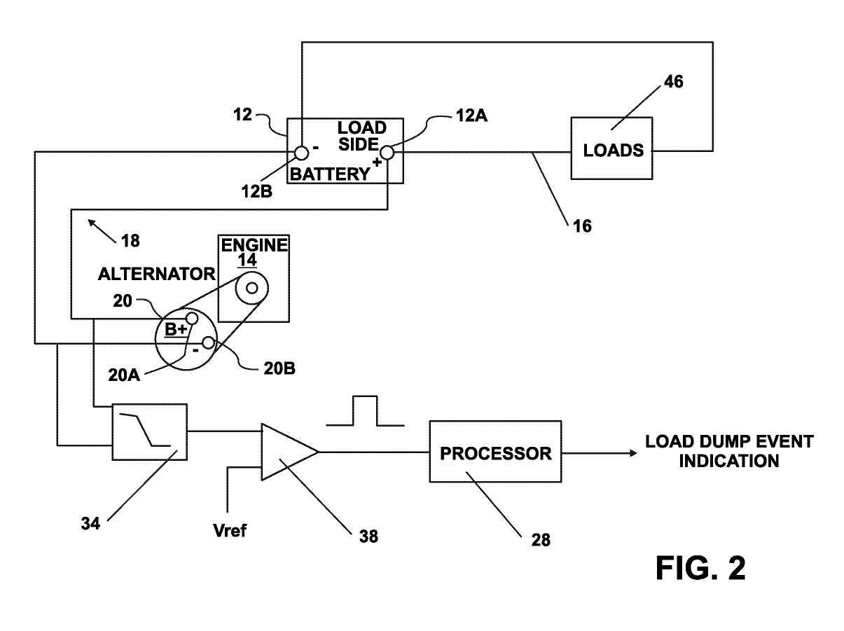

While it is contemplated that the detection functions be carried out using an existing voltage sensor 36 and vehicle controllers, the functionality can be realized, or represented, in analog circuit elements. FIG. 2 illustrates a possible realization/representation of a detection circuit with a low pass filter 34 connected across cabling 18, with an upper frequency limit calculated to exclude ignition and/or other high frequency noise occurring on cabling 18. An upper frequency limit of 10 Hz is a possible value. This value corresponds to the expected period for a load dump spike to be present, about 50 to 300 milliseconds. A level comparator 38 is connected to the output of the low pass filter 34 to determine if the voltage transient meets a minimum threshold. The output of the comparator could be supplied to a window timer or a timer channel on a microcontroller 28. The timer would measure the width of the pulse and discriminate whether a load dump event has occurred based on the time duration of the signal from the comparator. A pulse with between Tmin (50 millisecond) and Tmax (300 milliseconds) would be classified as being generated by a load dump event. Still other alternative circuit arrangements are possible.

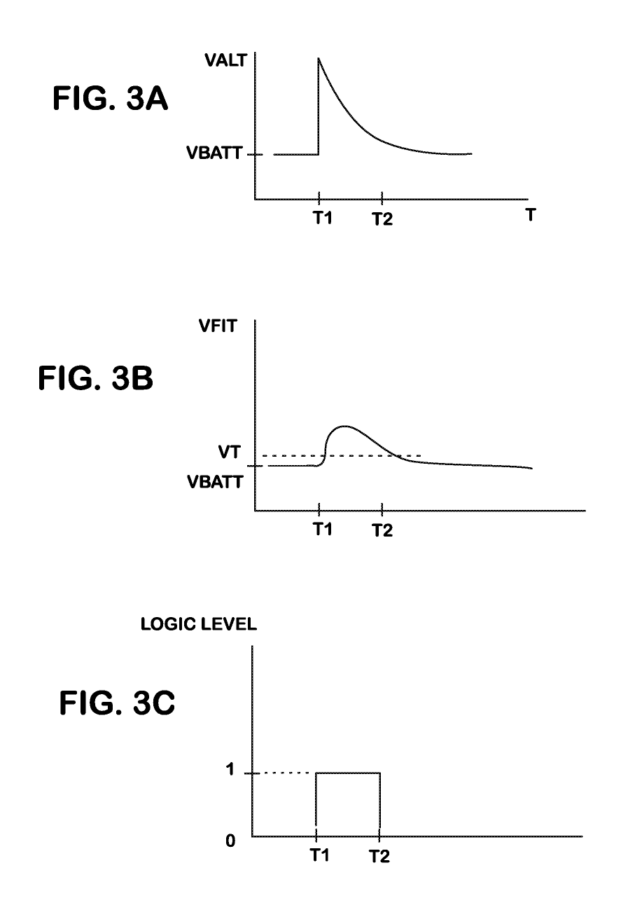

FIG. 3 graphically depicts the operation, whether executed in microcomputers or in analog circuits. FIG. 3A depicts voltage level against time on cabling 18 connecting alternator 20 with battery 12. A load dump occurs at time T1 resulting in a voltage spike characterized by a rapid increase in voltage on the cabling 18 from battery voltage Vbatt. The spike decays over time, but within the period T2-T1 where T2-T1 represents the filter window of the low pass filter which decays. Where the period associated with T2-T1 represents the window associated with low pass filter 34. Transient pulses associated with a load dump condition should match in duration and magnitude minimums associated with such events. Shorter term events are to be filtered out. Typically other noise occurring on vehicle cabling, such as switching events should either lower in energy or too short to be detected.

FIG. 3B depicts the output from the low pass filter 34 which is applied to a level comparator 48 to determine if the magnitude of the pulse is great enough to quality as a load dump event. This is done by comparison of the measured voltage with a reference voltage. FIG. 3C illustrates a logic high pulse generated by the level comparator 48 indicated an load dump event likely associated with a charging circuit interruption.

What is claimed is:

1. A vehicle electrical system, comprising:
a battery;
a direct current power source for charging the battery;
cabling and connectors between the direct current power source to the battery;
means for detecting voltage transients above the voltage level of the battery on the cabling above a minimum threshold;
means for timing a duration for detected voltage transients above the minimum threshold; and
means responsive to detection of a voltage transient exceeding the minimum threshold and the duration of the detected voltage transient falling between minimum and maximum duration limits for indicating a load dump event.

2. The vehicle electrical system of claim 1, further comprising:
the means for detecting voltage transients including a voltage sensor and an microcontroller.

3. The vehicle electrical system of claim 2, further comprising:
the microcontroller being programmed to implement a low pass filter for timing duration of voltage transients and a level comparator for determining voltage levels for the voltage transients.

4. The vehicle electrical system of claim 3, further comprising:
the microcontroller being a body controller.

5. The vehicle electrical system of claim 4, further comprising:
the direct current power source being an alternator.

6. A motor vehicle electrical system comprising:
a vehicle battery;
a direct current power source for charging the battery;
a circuit connection including the vehicle battery and direct current power source;
a voltage transient detector for determining if voltage levels on the circuit connection exceed a minimum threshold;
a filter which passes voltage transients of a minimum duration; and
an indicator responsive to detection of a voltage transient exceeding the minimum threshold and having a duration meeting minimum and maximum duration limits for signaling a load dump event.

7. The motor vehicle electrical system of claim 6, further comprising:
an engine control module;
a body controller;
a gauge controller with an associated output display;
a controller area network providing data exchange between the engine control module, the body controller and the gauge controller;
the engine control module and the body controller providing for implementing the voltage transient detector and filter; and
the gauge controller providing for display of qualifying voltage transient events.

8. The motor vehicle electrical system of claim 6, wherein:
the voltage transient detector is a voltage level comparator.

9. The motor vehicle electrical system of claim 6, wherein:
the filter is a low pass filter.
